(19) United States
(12) Patent Application Publication
(10) Pub. No.: US 2026/0093210 A1
(43) Pub. Date: Apr. 2, 2026

(54) TIMEPIECE COMPRISING AN OSCILLATING MASS AND A SHOCK-ABSORBING ORGAN

(71) Applicant: ETA SA MANUFACTURE HORLOGÈRE SUISSE, Grenchen (CH)

(72) Inventor: Julien CHRISTAN, Bienne (CH)

(73) Assignee: ETA SA MANUFACTURE HORLOGÈRE SUISSE, Grenchen (CH)

(21) Appl. No.: 19/329,669

(22) Filed: Sep. 16, 2025

(30) Foreign Application Priority Data
Oct. 1, 2024 (EP) 24203822.2

(51) Int. Cl. G04B 43/00

(52) U.S. Cl. CPC G04B 43/002

(57) ABSTRACT

A timepiece (1) including a case (10) in which an automatic horology movement (14) having an oscillating mass (15) is embedded, the case (10) being closed by a back (12) and by a glass (11). The timepiece (1) includes a shock-absorbing organ (16) made of an elastomeric polymer material, embedded in the case (10) and inserted between the oscillating mass (15) and the back (12) to prevent direct contact between the oscillating mass (15) and the back (12) in the event of shocks to the timepiece (1).

### CROSS REFERENCE TO RELATED APPLICATIONS

This application claims priority to European Patent Application No. 24203822.2, filed on October 1, 2024, the entire contents of which are incorporated herein by reference.

### TECHNICAL FIELD OF THE INVENTION

The present invention relates to a timepiece comprising an “automatic” horology movement, meaning a movement comprising an automatic winding mechanism equipped with an oscillating mass.

More specifically, the invention relates to a timepiece comprising a shock-absorbing organ to prevent contact between the oscillating mass and the back of the case of the timepiece in the event of accidental shocks.

### TECHNOLOGICAL BACKGROUND

If a timepiece undergoes a severe accidental shock, such as being dropped, the oscillating mass can be knocked against the back or the glass of a transparent back, which leaves a mark on the surface of the oscillating mass facing the back, thereby impairing the aesthetics of the horology movement, particularly when the oscillating mass is visible through the back.

Moreover, repeated shocks and friction between the oscillating mass and the back can generate particles of material that can affect the smooth functioning of the horology movement.

To remedy these drawbacks, several solutions have been proposed, in particular to limit the axial shake of the oscillating mass using axial stops such as pads, screws or stones.

Such a solution is particularly described in EP-924579. In this document, a notched end bead located on the outer rim of the oscillating mass is arranged between two rings to limit the axial shake of the oscillating mass during axial shocks.

Document CH-337785 also proposes a solution for reducing friction between the oscillating mass and the back in case of accidental contact by using horology stones embedded in the surface of the oscillating mass facing the back of the case.

However, these solutions are complex to implement and are not easily adaptable to existing calibres, for example in after-sales service.

Consequently, there is a need to improve timepieces equipped with automatic horology movements.

### SUMMARY OF THE INVENTION

To this end, the invention provides a timepiece comprising a case in which an automatic horology movement comprising an oscillating mass is embedded, said case being closed by a back, characterised in that the timepiece comprises a shock-absorbing organ made of an elastomeric polymer material, embedded in the case and inserted between the oscillating mass and the back to prevent direct contact between the oscillating mass and the back in the event of shocks to the timepiece.

In addition to the characteristics mentioned in the previous paragraph, the timepiece according to the invention can have one or more complementary characteristics from among the following, taken individually or in any technically possible combination:

The shock-absorbing organ is carried by the oscillating mass or by the back;

The shock-absorbing organ is secured to a surface on the oscillating mass or to a surface on the back;

The shock-absorbing organ is secured by gluing, soldering or clipping;

The shock-absorbing organ is embedded in at least one recess formed on a surface of the oscillating mass or on a surface of the back;

Said at least one recess is shaped to keep the shock-absorbing organ in position by clipping the shock-absorbing organ;

Said at least one recess is formed on a surface on the back facing the oscillating mass;

Said at least one recess is formed on a surface of the oscillating mass facing the back;

Said at least one recess extends over at least a peripheral portion of the oscillating mass or of the back;

Said oscillating mass or said back comprises a plurality of recesses and in that the shock-absorbing organ is composed of a plurality of shock-absorbing elements embedded in said plurality of recesses;

The recesses of the plurality are uniformly distributed over a peripheral part of the oscillating mass when they are carried by the oscillating mass.

### BRIEF DESCRIPTION OF THE FIGURES

The purposes, advantages and characteristics of the present invention will become apparent from the detailed description below in reference to the following figures:

FIG. 1 is a schematic cross-sectional view of a first exemplary embodiment of a timepiece according to the invention comprising a shock-absorbing organ inserted between the oscillating mass and the back; in this first exemplary embodiment, the shock-absorbing organ is carried by the back;

FIG. 2 is a schematic cross-sectional view of a second exemplary embodiment of a timepiece according to the invention comprising a shock-absorbing organ inserted between the oscillating mass and the back; in this second exemplary embodiment, the shock-absorbing organ is carried by the oscillating mass;

FIG. 3 more specifically shows a perspective view of the oscillating mass carrying the shock-absorbing organ of the second exemplary embodiment of the timepiece illustrated in FIG. 2 ;

FIG. 4 illustrates a third exemplary embodiment of a timepiece according to the invention in which the shock-absorbing organ is formed by a plurality of shock-absorbing elements carried by the oscillating mass and distributed over a peripheral portion of the oscillating mass in a plurality of recesses;

FIG. 5 illustrates a fourth exemplary embodiment of a timepiece according to the invention in which the shock-absorbing organ is formed by a plurality of shock-absorbing elements carried by the oscillating mass, extending radially relative to the axis of rotation of the oscillating mass and distributed over a peripheral portion of the oscillating mass;

FIG. 6 illustrates a fifth exemplary embodiment of a timepiece according to the invention in which the shock-absorbing organ is formed by a plurality of resilient spherical organs carried by the oscillating mass and distributed over a peripheral portion of the oscillating mass in a plurality of recesses.

In all of the figures, common elements have the same reference numbers unless otherwise specified.

### DETAILED DESCRIPTION OF THE INVENTION

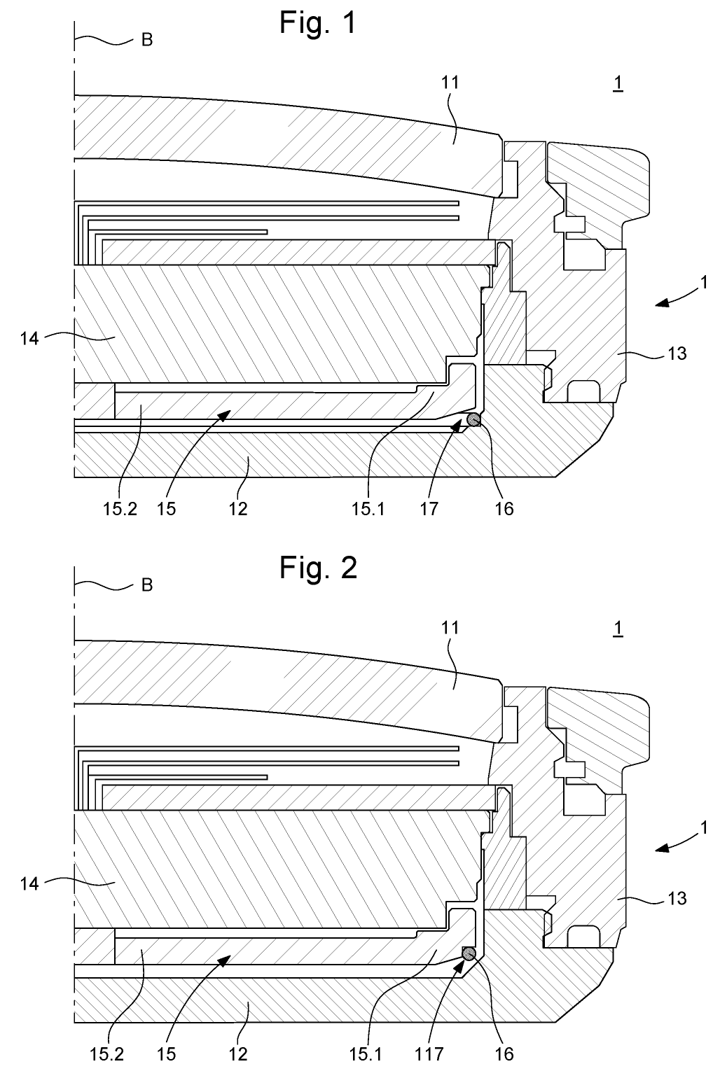

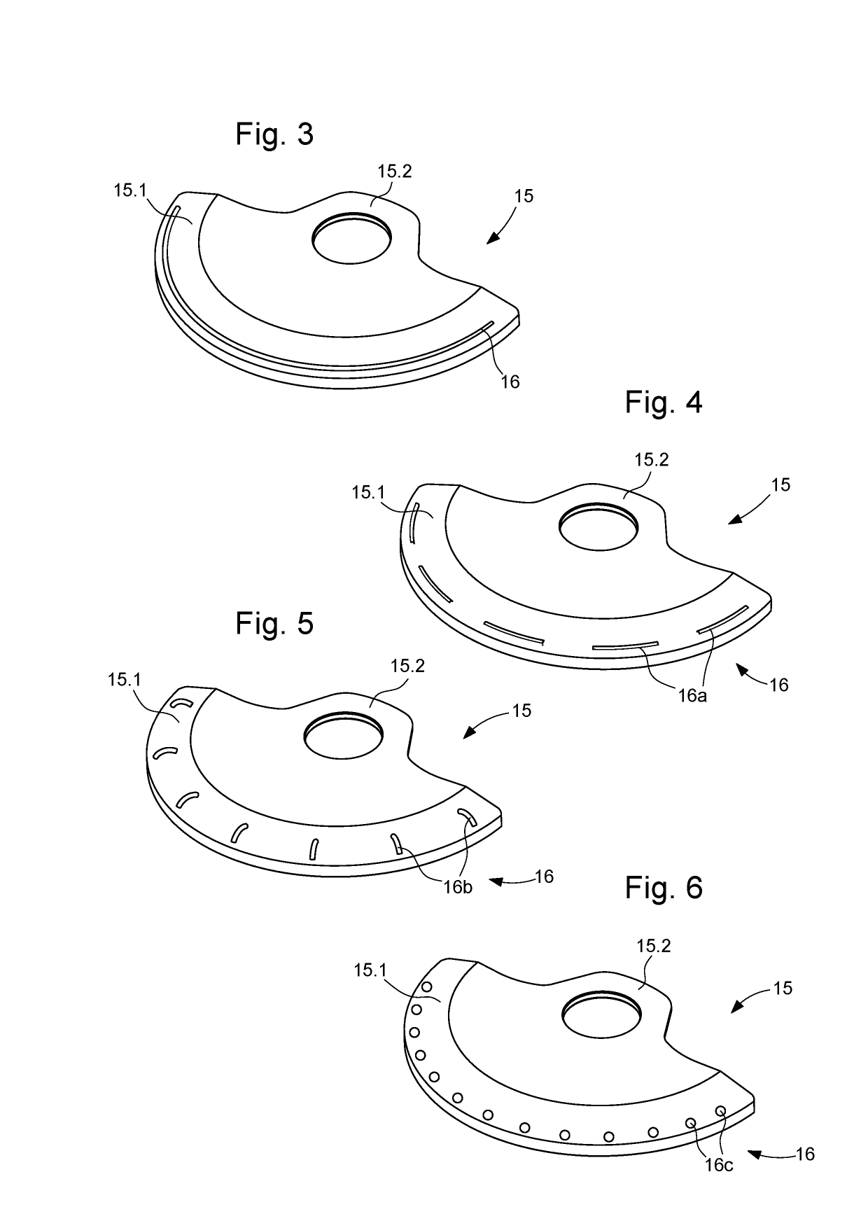

FIG. 1 is a schematic view, in partial cross-section, of a first exemplary embodiment of a timepiece 1 according to the invention.

The timepiece 1 comprises a case 10 with a middle 13 closed in the upper part by a glass 11 and in the lower part by a back 12.

The back 12 can be a solid back or an at least partially transparent back to make a horology movement 14 visible from the back 12.

The middle 13 delimits an inner space configured to receive and embed the horology movement 14 with central axis B.

The horology movement 14 is an automatic horology movement comprising an oscillating mass 15.

The oscillating mass 15 comprises a central part 15.2 forming the support for the oscillating mass 15 and a peripheral part 15.1 carrying a heavy sector. The oscillating mass 15 is secured to the horology movement 15 by appropriate fastening means.

Generally, the heavy sector of the peripheral part 15.1 is formed by an overthickness or by a high-density material.

The timepiece 1 also comprises a shock-absorbing organ 16 embedded in the case 10 and inserted between the oscillating mass 15 and the back 12.

Preferentially, the shock-absorbing organ 16 is inserted between the peripheral part 15.1 carrying the heavy sector of the oscillating mass 15 and the back 12.

Preferentially, the shock-absorbing organ 16 is inserted between the oscillating mass 15 and the back 12, in a region close to the radial end portion of the oscillating mass 15. In fact, it is in this region that displacements by elastic distortion, primarily of the central part 15.2 and of the fastening means, are greatest, and that the oscillating mass 15 is likely to come into contact with the back 12 in the event of shocks to the timepiece 1.

The shock-absorbing organ 16 is configured to prevent direct contact between the oscillating mass 15 and the back 12 in the event of shocks to the timepiece 1.

The shock-absorbing organ 16 is made of a damping and shock-absorbing material.

The shock-absorbing organ 16 is made of an elastomeric polymer material.

As shown in FIG. 1, the shock-absorbing organ 16 can be carried by the back 12 and be positioned on a surface of the back 12 facing the peripheral part 15.1 of the oscillating mass 15.

Preferentially, the shock-absorbing organ 16 is positioned on a surface of the back 12 facing the peripheral end of the oscillating mass 15.

As shown in FIG. 2, the shock-absorbing organ 16 can be carried by the oscillating mass 15 and positioned on a surface of the oscillating mass 15 facing the back 112.

According to one exemplary embodiment, the shock-absorbing organ 16 is positioned on the surface of the oscillating mass 15 or of the back 12 and secured, for example, by gluing, hot soldering or clipping.

According to another exemplary embodiment, the shock-absorbing organ 16 is embedded and kept in position in at least one recess 17, 117 made in a surface of the oscillating mass 15 or of the back 12.

For example, said at least one recess 117 is formed on a surface of the oscillating mass 15 facing the back 12 as shown in FIG. 2.

For example, said at least one recess 17 is formed on a surface of the back 12 facing the peripheral part 15.1 of the oscillating mass 15.

Said at least one recess 17, 117 is configured to receive and keep in position, by clipping or resilient compression of the material of the shock-absorbing organ 16.

The shock-absorbing organ 16 can also be glued in said at least one recess 17, 117.

For example, said at least one recess 17 continuously or discontinuously extends over at least one annular sector of the oscillating mass 15 or of the back 12.

For example, said at least one recess 17 is annular in shape and the shock-absorbing organ 16 is annular in shape, for example an O-ring. This embodiment is particularly suitable when the shock-absorbing organ 16 is carried by the back 12.

According to an alternative embodiment, the oscillating mass 15 or the back 12 comprises a plurality of recesses and the shock-absorbing organ is formed by a plurality of shock-absorbing elements embedded in the various recesses.

FIGS. 4 to 6 illustrate exemplary arrangements of the shock-absorbing organ 16 in the form of a plurality of shock-absorbing elements distributed over the circumference of the oscillating mass 15.

For example, as shown in FIG. 4, the oscillating mass 15 can comprise a plurality of recesses in the form of a plurality of annular sectors arranged on a circle, the centre of which is part of the axis of rotation of the oscillating mass 15. In this exemplary embodiment, the shock-absorbing organ 16 consists of a plurality of sections 16a kept in position in the various recesses.

For example, as shown in FIG. 5, the shock-absorbing organ 16 is formed by a plurality of shock-absorbing elements 16b secured to the surface of the peripheral part 15.1 of the oscillating mass 15. In this exemplary embodiment, the various shock-absorbing elements 16b can be glued to the surface of the peripheral part 15.1 and radially oriented relative to the rotational axis of the oscillating mass 15. Of course, the oscillating mass 15 can also comprise a plurality of recesses radially oriented relative to the axis of rotation of the oscillating mass 15 shaped to receive the plurality of shock-absorbing elements 16b and keep them in position.

For example, as shown in FIG. 6, the oscillating mass 15 can comprise a plurality of recesses distributed around the circumference of the oscillating mass 15 and the shock-absorbing organ 16 can be formed by a plurality of spherically-shaped shock-absorbing elements 16c kept in position in the various recesses.

1. A timepiece comprising a case in which an automatic horology movement with central axis comprising an oscillating mass is embedded, said case being closed by a back, wherein the timepiece comprises a shock-absorbing organ made of an elastomeric polymer material, embedded in the case and inserted between the oscillating mass and the back to prevent direct contact between the oscillating mass and the back in the event of shocks to the timepiece.

2. The timepiece according to claim 1, wherein the shock-absorbing organ is carried by the oscillating mass or by the back.

3. The timepiece according to claim 1, wherein the shock-absorbing organ is secured to a surface on the oscillating mass or to a surface on the back.

4. The timepiece according to claim 3, wherein the shock-absorbing organ is secured by gluing, soldering or clipping.

5. The timepiece according to claim 2, wherein the shock-absorbing organ is embedded in at least one recess formed on a surface of the oscillating mass or on a surface of the back.

6. The timepiece according to claim 5, wherein said at least one recess is shaped to keep the shock-absorbing organ in position by clipping the shock-absorbing organ.

7. The timepiece according to claim 5, wherein said at least one recess is formed on a surface of the back facing the oscillating mass.

8. The timepiece according to claim 5, wherein said at least one recess is formed on a surface of the oscillating mass facing the back.

9. The timepiece according to claim 5, wherein said at least one recess extends over at least a peripheral portion of the oscillating mass or of the back.

10. The timepiece according to claim 1, wherein said oscillating mass or said back comprises a plurality of recesses and in that the shock-absorbing organ is composed of a plurality of shock-absorbing elements embedded in said plurality of recesses.

11. The timepiece according to claim 10, wherein the recesses of the plurality are uniformly distributed over a peripheral part of the oscillating mass when they are carried by the oscillating mass.
